(19) United States
(12) Patent Application Publication
(10) Pub. No.: US 2014/0064673 A1
(43) Pub. Date: Mar. 6, 2014

(54) OPTOELECTRONIC CONNECTOR

(71) Applicant: Mou Lin HWANG, New Taipei City (TW)

(72) Inventor: Mou Lin HWANG, New Taipei City (TW)

(21) Appl. No.: 13/596,402

(22) Filed: Aug. 28, 2012

(51) Int. Cl. G02B 6/43

(52) U.S. Cl. 385/89

(57) ABSTRACT

An optoelectronic connector is used for data transmission in which an optoelectronic module is assembled on a first circuit board and is connected to an optical fiber line so as to conduct conversion between optical signals and electrical signals. A second circuit board is used to conduct information linking with the first circuit board through a transmission line. In this manner, the first circuit board and the second circuit board can conduct data transmission and reception through the optical fiber line of the first circuit board. Therefore, bidirectional data transmission can be carried out only by a single optoelectronic module.

### FIELD OF THE INVENTION

The present invention relates to an optoelectronic connector for data transmission, more particularly to an optoelectronic connector in which data transmission is conducted through a single optoelectronic module so as to achieve the purpose of cost-effective manufacturing.

### RELATED ART

Due to communication needs and significant increase of data transmission, the traditional means of communication of using coaxial cable as transmission media has been inadequate to meet the requirement, and thus optical fiber as a means of transmission media have been widely adopted, and this has resulted in the advent of the era of optical fiber transmission. Referring to FIG. 1, a schematic view of a conventional optoelectronic connector for data transmission is shown. An optoelectronic connector 10 as shown in the figure comprises a first circuit board 101 having a first optoelectronic module 1011, and a second circuit board 102 having a second optoelectronic module 1021. The first optoelectronic module 1011 and the second optoelectronic module 1021 are separately connected with optical fibers (11, 11′) (which can be single-core or a multi-core optical fibers). Furthermore, the first circuit board 101 and the second circuit board 102 include separately a first data transmission port 1012 and a second data transmission port 1022. Then, the first circuit board 101 and the second circuit board 102 are assembled in a connection head 103 so as to form a completed optoelectronic connector 10. Then, users can link the optoelectronic connector 10 between opposite data transmission facilities so as to carry out data transmission. As mentioned above, the first circuit board 101 and the second circuit board 102 of the optoelectronic connector 10 are separately provided with the first optoelectronic module 1011 and the second optoelectronic module 1021 which are respectively connected with two optical fibers (11, 11′). As the optoelectronic module and the optical fiber line are primary components for transmitting data among all components of the optoelectronic connector 10, so their manufacturing costs account for a large proportion, and this may result in the relative increase of the overall manufacturing cost of the optoelectronic connector 10. Therefore, how to effectively reduce the manufacturing costs is one of the issues to be addressed.

### SUMMARY OF THE INVENTION

In view of the above problems, the main object of the present invention is to provide an optoelectronic connector that can conduct bidirectional data transmission only by a single optoelectronic module, so as to effectively reduce the manufacturing cost of the optoelectronic connector.

In order to achieve above object, the optoelectronic connector of the present invention mainly comprises a first circuit board and a second circuit board separately assembled within a connecting head in such a manner that the connecting head, after linking to relevant facilities, can conduct data transmission and reception through the first circuit board and the second circuit board. The first circuit board has a first optoelectronic module to be in information linking with an optical fiber line which may be a single-core or a multi-core optical fiber. Furthermore, a connection line is used to accomplish information linking between the first circuit board and the second circuit board. In this manner, the first circuit board and the second circuit board can conduct data transmission and reception through the optical fiber line of the first circuit board. Therefore, data transmission can be carried out only by a single optoelectronic module to achieve the cost-effective manufacturing purpose.

### BRIEF DESCRIPTION OF THE DRAWINGS

FIG. 1 is a schematic view showing the structure of a conventional optoelectronic connector.

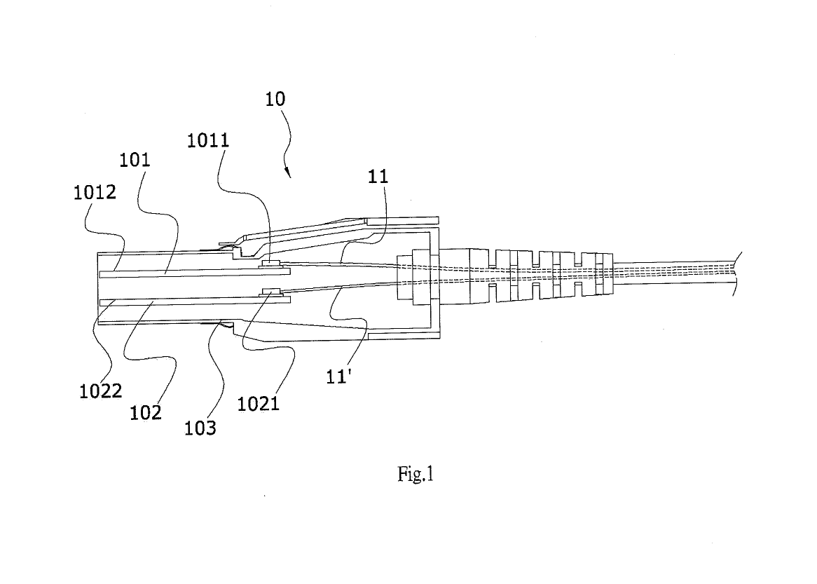

FIG. 2 is an exploded schematic view showing the components of the present invention.

FIG. 3 is a schematic view showing the components of the present invention.

FIG. 4 is a schematic view showing the final assembly of the present invention.

FIG. 5 is a schematic view of the implementation of the present invention.

### DETAILED DESCRIPTION OF THE INVENTION

The objects, the technical contents and the expected effect of the present invention will become more apparent from the detailed description of the preferred embodiment in conjunction with the accompanying drawings.

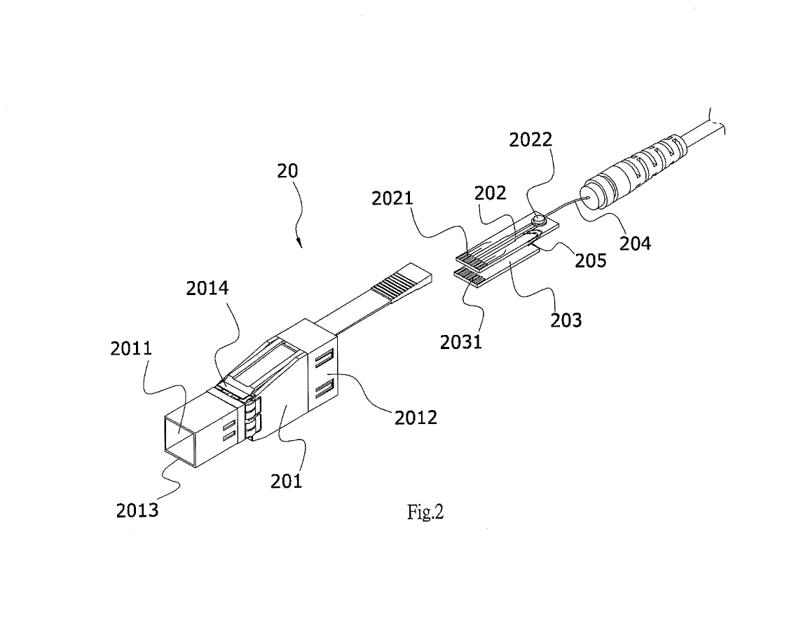

FIG. 2 is a schematic exploded view showing the parts formation of the present invention. As shown in the figure, an optoelectronic connector 20 is mainly formed by a connecting head 201, a first circuit board 202 and a second circuit board 203. The connecting head 201 is hollow so as to form an accommodation space 2011 for receiving the first circuit board 202 and the second circuit board 203. An assembly end 2012 and an open end 2013 are formed on two ends of the accommodation space 2011 separately, and the connecting head 201 has a snap fit 2014 provided at the outside thereof for accomplishing the engagement after the optoelectronic connector 20 is connected to corresponding electronic facility. A first circuit board 202 is, for example, a printed circuit board (PCB), one end of the first circuit board 202 is formed with a first data transmission port 2021 (i.e., edge connector) and the other end is assembled with a optoelectronic module 2022. The optoelectronic module 2022 can conduct bidirectional data transmission through an optical fiber line 204 (which can be a single-core or a multi-core optical fiber) when connected therewith. The second circuit board 203 can also be formed by a printed circuit board (PCB), one end of the second circuit board 203 is formed with a second data transmission port 2031 (i.e., edge connector). Information linking between the second circuit board 203 and the first circuit board 202 can be accomplished through a connecting line 205 which can be a single-core or a multi-core optical fiber. The connecting line 205 can be used to transmit information data between the first circuit board 202 and the second circuit board 203. The material of the connecting line 205 can be a copper wire for transmitting data signals, or the connecting line 205 can be a flexible bus.

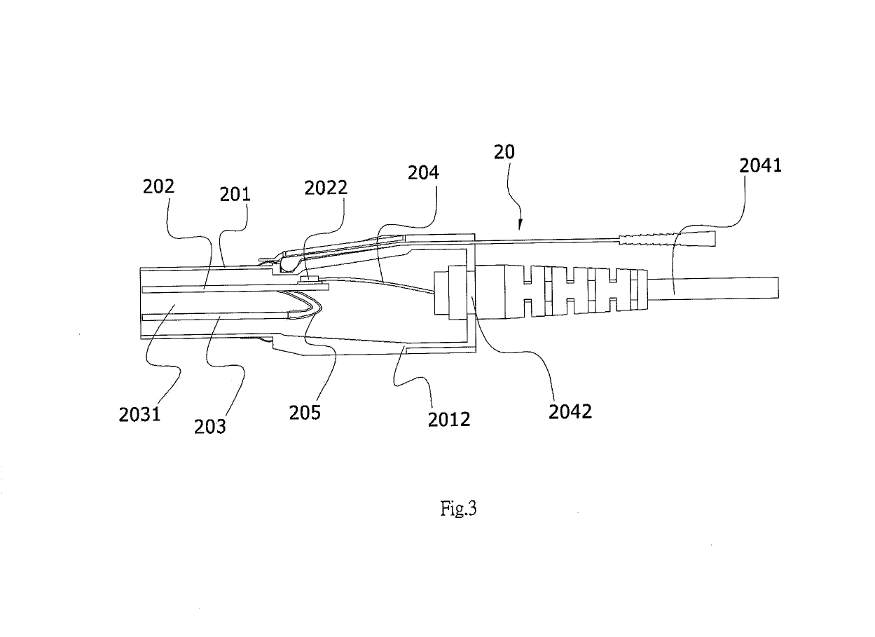

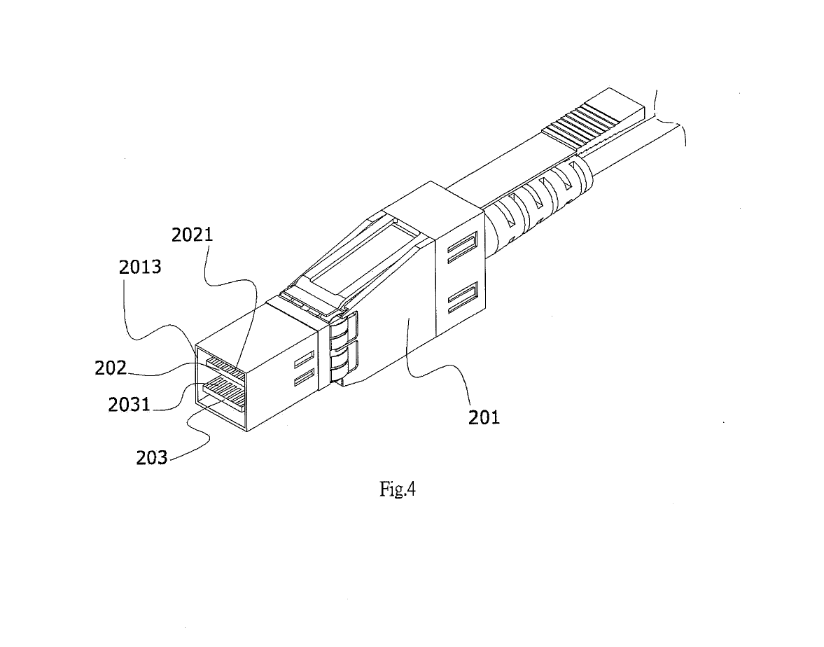

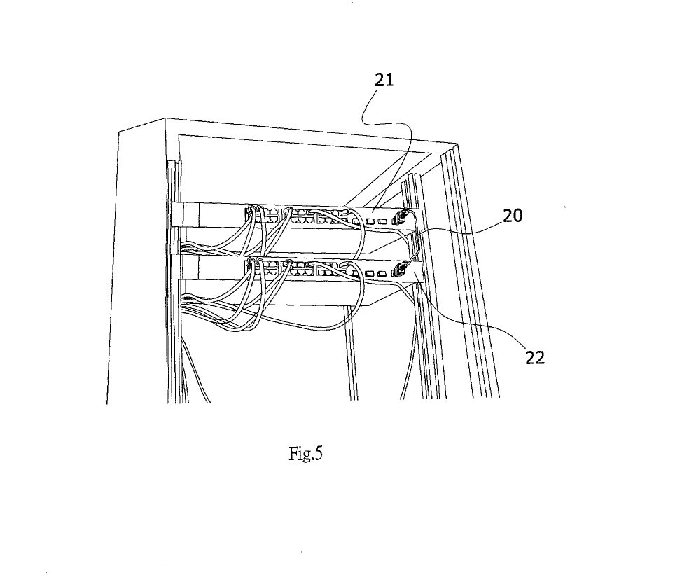

FIG. 3 is a schematic view showing the components of the present invention. As shown in the figure, the first circuit board 202 and the second circuit board 203 of the optoelectronic connector 20 are connected by the connecting line 205 and are further assembled within the connecting head 201 so that associated components including the first circuit board 202 and the second circuit board 203 can be protected by the connecting head 201. Further, the first circuit board 202 is relatively disposed above (or below) the second circuit board 203 in such a manner as to be opposite to each other in normal state. Further, after the first circuit board 202 and the second circuit board 203 are assembled within the connecting head 201, the first data transmission port 2021 and the second data transmission port 2031 (as shown in FIG. 2) are disposed at the open end 2013 of the connecting head 201 so as to be exposed in normal state. Moreover, the external part of the optical fiber 204 has an outer sheath 2041 in normal state, and the outer sheath 2041 has a securing member 2042 provided at the end thereof for securing at the assembly end 2012 so that the optical fiber 204 can be secured to the connecting head 201. Further, the abovementioned connecting line 205 is disposed between the first circuit board 202 and the second circuit board 203 for data signal transmission between the first circuit board 202 and the second circuit board 203, and the linking accomplished between the optoelectronic module 2022 of the first circuit board 202 and the optical fiber line 204 can conduct the conversion between the optical signals and the electrical signals. According to the above description , as the information linking is accomplished between the first circuit board 202 and the second circuit board 203 through the connecting line 205, the second circuit board 203 can transmit data to the first circuit board 202 through the connecting line 205 when data are received separately by the two data transmission ports (2021,2031), and the data received are converted into optical signals by the optoelectronic module 2022 of the first circuit board 202 so that the optical signals can be transmitted through the optical fiber line 204. On the contrary, the optical signals transmitted through the optical fiber line 204 can also be converted into electrical signals by the optoelectronic module 2022, and the electrical signals are further transmitted to the two data transmission ports (2021, 2031) of the two circuit boards (202, 203) through the connecting line 205 so as to conduct further transmission. The configuration accomplished by the assembly of the above components is schematically shown in FIG. 4. As shown in the figure, after the assembly of the components of the present invention, the first data transmission port 2021 and the second data transmission port 2031 are separately exposed at the open end 2013 of the connecting head 201 such that the connecting head 201 can be coupled to the first data transmission port 2021 and the second data transmission port 2031 for data transmission. Referring to FIG. 5 showing schematically the implementation of the present invention, two transmission lines with the same structure are separately attached to both ends of the optoelectronic connector 20 of the present invention. In the above description, only the whole structure of one end is described, but the structure of the other end is completely the same and hence the description thereof is omitted. Further, according to the description in FIG. 4, the optoelectronic connector 20 is connected to the corresponding information facilities such as two servers (21, 22) as shown in the figure. The present invention can conduct data transmission by a single optoelectronic module 2022 connected between the two servers (21, 22), so as to effectively reduce the overall manufacturing cost of the optoelectronic connector 20.

Based on foregoing, the present invention can conduct the conversion between the optical signals transmitted through the optical fiber and the electrical signals by the optoelectronic module provided on the first circuit board, and the data signals are further transmitted to the first data transmission port and simultaneously transmitted to the second data transmission port of the second circuit board through the connecting line between the first circuit board and the second circuit board, so that two data transmission ports can conduct data transmission only by a single optoelectronic module. In this manner, the present invention, after practical implementation, can assuredly provide an optoelectronic connector that can conduct bidirectional data transmission by using only a single optoelectronic module so as to effectively reduce the manufacturing cost of the optoelectronic connector.

While the present invention has been described by preferred embodiments in conjunction with accompanying drawings, it should be understood that the embodiments and the drawings are merely for descriptive and illustrative purpose, not intended for restriction of the scope of the present invention. Equivalent variations and modifications conducted by person skilled in the art without departing from the spirit and scope of the present invention should be considered to be still within the scope of the present invention.

What is claimed is:

1. An optoelectronic connector for bidirectional data transmission, comprising:
a connecting head having an accommodation space with two ends formed separately as an open end and an assembly end;
a first circuit board assembled within said accommodation space, one end of said first circuit board being formed with a first data transmission port and the other end thereof being assembled with an optoelectronic module; said first data transmission port being adjacent to said open end of said connecting head and said optoelectronic module being adjacent to said assembly end of said connecting head after said first circuit board being assembled within said accommodation space;
a second circuit board, one end of said second circuit board being formed with a second data transmission port and the other end of said second circuit board being in Information linking with said optoelectronic module of said first circuit board through a connecting line; said second data transmission port being adjacent to said open end of said connecting head after said second circuit board being assembled within said accommodation space; and
an optical fiber line passing through said assembly end of said connecting head and connected to said optoelectronic module of said first circuit board.

2. The optoelectronic connector as claimed in claim 1, wherein the external part of said connecting head is provided with a snap fit.

3. The optoelectronic connector as claimed in claim 1, wherein the outer surface of said optical fiber has an outer sheath which has a securing member provided at one end thereof for securing at said assembly end.

4. The optoelectronic connector as claimed in claim 1, wherein said connecting line is a single-core wire.

5. The optoelectronic connector as claimed in claim 1, wherein said connecting line is a multi-core wire.

6. The optoelectronic connector as claimed in claim 1, wherein said connecting line is a flexible bus.

7. The optoelectronic connector as claimed in claim 1, wherein said connecting line is a copper wire.

8. The optoelectronic connector as claimed in claim 1, wherein said optical fiber line is a single-core optical fiber.

9. The optoelectronic connector as claimed in claim 1, wherein said optical fiber line is a multi-core optical fiber.
